(19) United States
(12) Patent Application Publication
(10) Pub. No.: US 2023/0274649 A1
(43) Pub. Date: Aug. 31, 2023

(54) DEVICE AND METHOD FOR ASSISTING AIRCRAFT GUIDANCE

(71) Applicant: THALES, Courbevoie (FR)

(72) Inventors: Emmanuel DEWAS, FROUZINS (FR); Geoffrey DURAND, TOULOUSE (FR)

(21) Appl. No.: 18/014,730

(22) PCT Filed: Jul. 20, 2021
(86) PCT No.: PCT/EP2021/070224

§ 371 Date: Jan. 5, 2023

(30) Foreign Application Priority Data
Jul. 22, 2020 (FR) FR2007709

(51) Int. Cl. G08G 5/00

(52) U.S. Cl. CPC G08G 5/0021; G08G 5/003; G08G 5/0047

(57) ABSTRACT

The present invention relates to a device and a method for assisting aircraft guidance. The method for assisting aircraft guidance is operated by a computation platform for aircraft and comprises steps:
of acquisition of state variables characterizing an aircraft in flight, of environment variables characterizing the environment of the aircraft and of trajectory variables characterizing a reference trajectory of the aircraft;
of calculation of a predicted real trajectory for an upcoming change of direction of the aircraft, based on said state variables, on said environment variables and on said reference trajectory variables;
of determination of conformity to determine if the predicted real trajectory which is calculated conforms or does not conform to the reference trajectory; and
of configuration of a trajectory deviation alert, when the predicted real trajectory does not conform to the reference trajectory.

### FIELD OF THE INVENTION

The invention relates to the field of flight management systems, and more particularly to that of assisting aircraft guidance along a predefined trajectory.

### STATE OF THE ART

One of the functions of a flight management system (FMS) is to calculate a trajectory (lateral and vertical) in order to guide an aircraft thereon during a flight. Insofar as is possible, the trajectory, and notably the lateral trajectory, is calculated to be consistent with technical capabilities that the aircraft can follow. Among the technical capabilities of an aircraft, there is a maximum roll criterion that the latter must be able to observe.

Thus, an aircraft guidance system on a trajectory consists notably in guiding the latter on a lateral axis by controlling its roll to lock it onto this trajectory, while observing a roll threshold value (“maximum roll”) which is predefined for the type of aircraft concerned. Indeed, either for reasons linked to flight mechanics, or to guarantee the safety or the comfort of the passengers, an aircraft cannot exceed a given maximum roll.

In the embedded systems like the FMSs, the trajectory which is calculated must allow the aircraft to fly this trajectory while observing the maximum roll criterion. This type of computer makes it possible to predict the speed of the aircraft at the different waypoints (WPT) of a turn and adjust the turn radii as required. FIG. 1 illustrates a trajectory to be flown for an aircraft over a curved segment, in which the radius of the turn is calculated according to the following equation (1):

$$Radius = \frac{{V}^{2}}{g \cdot tan ( roll )} with V the predicted speed$$

In order to avoid turns with excessively low roll and the operational drawbacks which are associated therewith, such as, for example, the elongation of the distance and therefore of the flight time, the trajectory is calculated with a target roll which is close to the maximum roll. Generally, a slight margin (nominally 5°) is nevertheless taken into account in the construction of the trajectory to absorb the guidance corrections while flying the curved segment.

However, in some situations, the maximum roll criterion cannot be observed and the aircraft is then in deviation with respect to the calculated trajectory.

A first case in which the maximum roll cannot be observed is over a curved trajectory segment in which the speed of the aircraft is not always constant. One solution to avoid exceeding maximum roll consists in predicting the acceleration of the aircraft and taking that into account in the calculation of the turn radius, in order to guarantee a maximum roll value. Nevertheless, this calculation may be errored by the real wind being poorly taken into account and/or a poor modelling of the aircraft performance levels for example, resulting in a radius calculation that cannot be followed by the aircraft.

A second real case in which the maximum roll is not observed can occur during the acceleration of an aircraft in a turn. In fact, a major drawback in calculating a turn ensuring that a maximum roll value will not be exceeded is to construct large turns which are not always so compatible to be put into practice by aircraft. Such large turns can lead to a small roll at the start of a turn, an elongation of the flight distance, but also an overflight of prohibited zones such as inhabited zones. One effect of these consequences is that, deliberately because of these operational constraints, the radius of the turn is sometimes underestimated in the calculation, and the aircraft is then locked onto this trajectory until the maximum roll is reached, then it deviates from the trajectory.

A third case that presents the risk of non-observance of a maximum roll is linked to the fact that a trajectory which is calculated is constructed also as consistent with the outcome expected from the maps, that is to say with a theoretical speed imposed by the procedures, independently of the real speed. The calculated trajectory thus becomes the reference, and consequently, the radius of a turn may sometimes be underestimated in light of the effective speed, and the aircraft is then locked onto this trajectory until the maximum roll is reached, then it deviates from the trajectory.

When an aircraft has deviated from a trajectory, the known solutions are based on a system which issues an alert once the aircraft has deviated with respect to this trajectory. The alert can be made to the crew by the display of the lateral deviation value between the aircraft and this trajectory (also known as “cross track error” or “XTK”), or by the updating of the trajectory in real time while the turn is being flown to indicate the real trajectory of the aircraft, or even by the display of the flight trajectory based on the current roll. It is then essential for the crew to manage the situation instantly and while the problem exists, either by allowing the aircraft to drift from the trajectory if the situation permits, or by applying corrections such as a reduction of the speed, or by manually taking control of the aircraft.

The drawback with these solutions and, more generally, with the solutions based on alerts triggered after the fact, is that these alerts are too late with respect to the occurrence of a problematical situation, because these systems provide information once an error has been observed.

The known alert systems do not make it possible to anticipate a situation and warn a crew in advance in order to allow it to take corrective actions upstream, such as, for example, reducing the speed of the aircraft, to avoid a future error.

One aim of the invention is to mitigate the drawbacks of the known alert solutions, and to propose a predictive trajectory-following alert device.

### SUMMARY OF THE INVENTION

One object of the present invention is to propose a method that makes it possible to predict a real trajectory of an aircraft and to be able to warn a crew or a guidance system in advance of the impossibility of flying a reference trajectory in normal conditions.

Another object of the invention is to propose a device which comprises means making it possible to implement the claimed method.

Advantageously, the device and the method of the invention make it possible to provide information to a crew or to a guidance system in a time prior to the occurrence of a problematical situation, notably that in which an aircraft will be in deviation from a predefined trajectory.

To obtain the results sought, methods, devices and computer program products are described.

Generally, the invention consists in calculating, for an upcoming change of direction of an aircraft (i.e. a turn), a predicted real trajectory, and one which, depending on whether it conforms or does not conform to a reference trajectory, will make it possible to trigger an alert to a crew and/or to a guidance system.

In particular, a method for assisting aircraft guidance, operated by a computation platform for aircraft, comprises at least:
a step of acquisition of state variables characterizing an aircraft in flight, of environment variables characterizing the environment of the aircraft and of trajectory variables characterizing a reference trajectory of the aircraft;
a step of calculation of a predicted real trajectory for an upcoming change of direction of the aircraft, based on said state variables, on said environment variables and on said reference trajectory variables;
a step of determination of conformity to determine if the predicted real trajectory which is calculated conforms or does not conform to the reference trajectory; and
a step of configuration of a trajectory deviation alert, when the predicted real trajectory does not conform to the reference trajectory.

According to alternative embodiments, the calculation of predicted real trajectory can be done according to two distinct variants. In a first implementation, the method will make it possible to predict the real roll of the aircraft for the upcoming turn. In another implementation of the method, it is a calculation of prediction of the real position of the aircraft for the upcoming turn.

According to alternative or combined embodiments:
the step of calculation of a predicted real trajectory consists in calculating prediction variables characterizing the prediction of a roll of the aircraft and/or the prediction of a position of the aircraft, for an upcoming change of direction of the aircraft;
the conformity determination step consists in comparing the values of said prediction variables to predefined threshold values for the reference trajectory of the aircraft;
the conformity determination step consists in verifying if the predicted roll value is greater than a predefined maximum roll value and/or in verifying if the predicted position of the aircraft corresponds to a lateral deviation value greater than a predefined maximum lateral deviation value;
the step of calculation of a predicted real trajectory comprises an initial step of determination of the position of the aircraft with respect to an upcoming change of direction, making it possible to determine if the aircraft is situated before the upcoming change of direction or if the aircraft has already engaged in the turn corresponding to the change of direction;
the step of calculation of a predicted real trajectory consists in implementing a simulation function to predict a real trajectory of the aircraft, either from the start of the turn for the turn to be flown, or from the current position of the aircraft in the turn for the turn segment remaining to be flown.

The invention relates also to a device for assisting aircraft guidance which comprises means for:
acquiring state variables characterizing an aircraft in flight, environment variables characterizing the environment of the aircraft and trajectory variables characterizing a reference trajectory of the aircraft;
calculating a predicted real trajectory of the aircraft for an upcoming change of direction of the aircraft, based on said state variables, on said environment variables and on said reference trajectory variables;
determining if the predicted real trajectory which is calculated conforms or does not conform to the reference trajectory; and
configuring a trajectory deviation alert, when the predicted real trajectory does not conform to the reference trajectory.

The device further comprises means configured to operate the steps of the method claimed.

The invention also covers a flight management system (FMS) or an embedded computation system of EFB type which comprises a device for assisting aircraft guidance as claimed.

The invention relates also to a computer program product which comprises code instructions making it possible to perform the steps of the method claimed, when the program is run on a computer.

### DESCRIPTION OF THE FIGURES

Different aspects and advantages of the invention will emerge in light of the description of a preferred nonlimiting mode of implementation of the invention, with reference to the figures below:

FIG. 1 illustrates a trajectory to be flown for an aircraft over a curved segment;

FIG. 2 illustrates the general steps of the method of the invention in an embodiment;

FIGS. 3a and 3b illustrate two variants of display of a predicted real trajectory for a curved segment according to the calculation of a predicted real roll;

FIGS. 4a and 4b illustrate two variants of display of a predicted real trajectory for a curved segment according to the calculation of a predicted real position;

FIG. 5 illustrates the steps of a variant embodiment of the method of the invention;

FIG. 6 and FIG. 7 are representations of the parameters used for the real roll prediction calculation;

FIG. 8 and FIG. 9 are representations of the parameters used for the real position prediction calculation; and

FIG. 10 illustrates a structure of a flight management system (FMS) making it possible to implement the device and the method of the invention.

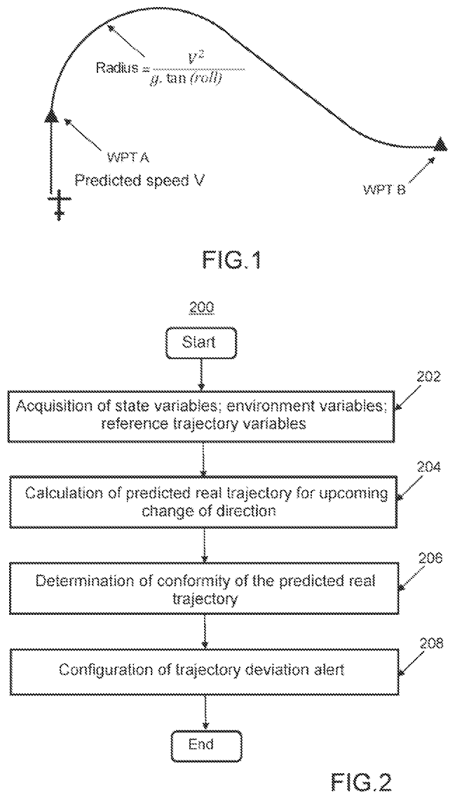

### DETAILED DESCRIPTION OF THE INVENTION

When an airplane flies a path between two airports, a flight plan (FPLN) is filed, in order to inform the air navigation departments thereof. This contains all the information specified regarding the projected flight or a part of the flight, and in particular:
the airplane type;
the time of departure;
the first flight level requested for cruising;
the onboard equipment;
the planned route.

The flight plan between a point of departure and a point of arrival to be reached contains a set of waypoints (WPT) that are ordered in a predetermined manner, in which, at each waypoint, a change of heading or of altitude or of speed must take place. A waypoint is defined by a geographic position and latitudinal and longitudinal coordinates. All these points can be chosen from among points predefined in a navigation database, and can correspond to airports, to radio navigation beacons, etc.

To follow its flight plan, an airplane uses a flight management system (FMS). The FMS is an embedded navigation aid system, which incorporates information on the performance of the airplane and on its position, information from navigation sensors, from the flight plan which is stored and from manual inputs. Its aim is to assist the pilots, by providing, via a suitable human-machine interface, piloting instructions, or to allow automatic guidance of the airplane along the trajectory when it is coupled with the automatic pilot. In order to guide the aircraft to follow its flight plan, the FMS uses different sensors to determine the current position of the airplane (PPOS) and the accuracy of this position. The accuracy is defined as the degree of conformity between the estimated, measured or desired position, and the real position of the aircraft at a given instant. The FMS also allows the pilot to modify the flight plan, during the flight, for various reasons such as a delay induced by bad weather conditions to be avoided, or by requests imposed by air traffic management (ATM) organs. At regular intervals, based on the points of the flight plan, the FMS calculates a lateral trajectory. Based on the cruising level and on the altitude constraints, the FMS also calculates a vertical profile. Based on the speed constraints and on the optimized speeds of each flight phase, and as a function of a cost index which is chosen by the airline, the FMS calculates a speed profile. Given the flight plan and the position of the airplane, the FMS calculates the reference trajectory to be followed which is a succession of straight and curved segments. The points linking the segments of the reference trajectory can correspond to waypoints of the flight plan, or be different.

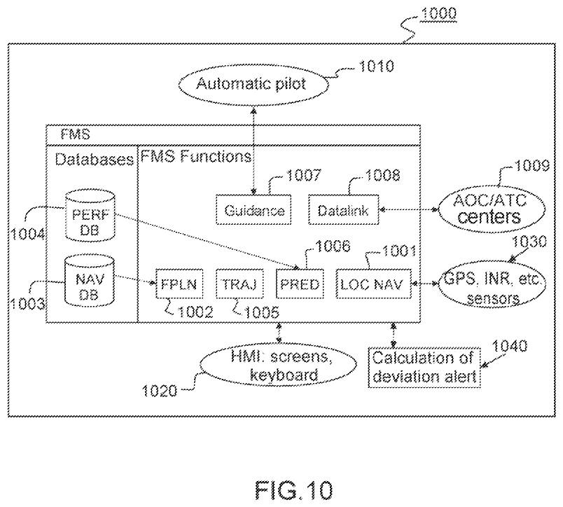

FIG. 10 illustrates a structure of a flight management system making it possible to implement the method of the invention. For example, the system can be a flight management system of FMS type (1000), comprising components suitable for performing the known functionalities and also incorporating an alert computation module (1040) configured to implement the method of the invention.

A known system of FMS type has a human-machine interface (1020) comprising for example a keyboard and a display screen, or quite simply a touch display screen, and modules making it possible to perform at least the following functions:
navigation (LOCNAV) (1001) to perform the optimal locating of the aircraft as a function of the geolocation means (1030) such as geo-positioning by satellite or GPS, GALILEO, VHF radio navigation beacons, inertial units. This module communicates with the geolocation devices;
flight plan (FPLN) (1002), for inputting the geographic elements constituting the skeleton of the route to be followed, such as the points imposed by the departure and arrival procedures, the waypoints, and the air routes, or “airways”;
navigation database (NAVDB) (1003), for constructing geographic routes and procedures based on data included in the bases relating to the points, beacons, interception or altitude legs, etc.;
performance database (PERFDB) (1004), containing aerodynamic and engine performance parameters of the aircraft;
trajectory (TRAJ) (1005), for constructing an optimized and continuous 4D trajectory, from the points of the flight plan and the associated constraints, observing the performance levels of the aircraft and the confinement constraints (RNP);
predictions (PRED) (1006), for supplying the predictions (altitude, time, fuel) over all the points of the flight plan;
guidance (GUID) (1007), for providing commands making it possible to guide the aircraft along the lateral plane, the vertical profile and the speed profile;
digital datalink (DATALINK) (1008), for communicating with the control centers and other aircraft (1009).

According to one mode of implementation, the method claimed is borne by a specific partition of a hardware platform specific to avionics but different from that of the FMS, such as, for example, a device of “electronic flight bag” (EFB) type. According to another preferred embodiment, this calculation is performed on the FMS run time platform, by components (1040) suited to the calculations. In fact, the advent of integrated modular avionics on recent aircraft has allowed the definition of run time platforms and of digital communication between the functions. This trend has however led to an increase in complexity—notably the internal complexity of the functions, but also the complexity of the avionics system configuration process—and growing performance and resource optimization requirements. In this context, the new hardware platforms are provided with management (operations, safety and maintenance), energy optimization and location capabilities, which go beyond the standard functions of the known platforms.

According to another aspect, the invention relates to a computer program product comprising code instructions making it possible to perform the steps of the method according to the invention. The method can be implemented on the basis of hardware and/or software elements. The method can be available as computer program product on a computer-readable medium. The method can be implemented on a system that can use one or more dedicated electronic circuits or one general-purpose circuit. The technique of the method according to the invention can be implemented on a reprogrammable computation machine (a processor or a microcontroller for example) running a program comprising a sequence of non-transient instructions, or on a dedicated computation machine (for example a set of logic gates such as an FPGA or an ASIC, or any other hardware module). The different modules of the system according to the invention can be implemented on one and the same processor or on one and the same circuit, or distributed over several processors or several circuits. The modules of the system according to the invention consist of computation means including a processor. The reference to a computer program which, when it is run, performs any one of the functions described previously, is not limited to an application program that is run on a single host computer. On the contrary, the terms computer program and software are used here in the general sense to refer to any type of computer code (for example, application software, firmware, microcode, or any other form of computer instruction) which can be used to program one or more processors to implement aspects of the techniques described here.

FIG. 2 illustrates the general steps of the method of the invention in one embodiment. Generally, the method consists in doing a calculation of real trajectory prediction (called “predicted real trajectory”) for an upcoming change of direction of an aircraft, then generating an alert if the predicted real trajectory does not observe a reference trajectory or a predefined trajectory.

The method 200 begins with a step 202 of acquisition of several types of variables relating to an aircraft, and in particular:
state variables comprising at least: the current situation of the aircraft such as its position, its roll, its speed, its altitude;
environment variables comprising at least: the current or predicted weather around the aircraft;
reference trajectory variables comprising at least: the curved segment making it possible to make the upcoming change of direction, the maximum roll of the aircraft and, if required, the planned vertical changes in terms of speed or altitude.

In a next step 204, the method makes it possible to use the current values of the different variables to make a calculation of prediction of the real trajectory of the aircraft for an upcoming change of direction of the aircraft. In the context of the invention, a change of direction corresponds to a turn or curved segment characterized by different parameters, in particular:
a start of turn;
an end of turn;
a radius R of the turn.

The calculation of the predicted real trajectory is done for a curved segment defined by turn start, end and radius parameters. In one embodiment, the step of calculation of the predicted real trajectory consists in calculating the prediction variables characterizing the prediction of a real roll of the aircraft along the curved segment. In another embodiment, the step of calculation of the predicted real trajectory consists in calculating prediction variables characterizing the prediction of a real position of the aircraft during the turn.

In a next step 206, the method makes it possible to determine the conformity of the predicted real trajectory to the reference trajectory of the aircraft for the turn concerned. The conformity determination step can consist in comparing the values of the real roll prediction variables or in comparing the values of the prediction variables of the real position of the aircraft to predefined threshold values for the reference trajectory of the aircraft.

In one embodiment, the comparison consists in verifying if the predicted real roll value is greater or not than a predefined maximum roll value. In another embodiment, the comparison consists in verifying if the lateral deviation of the predicted real position of the aircraft is greater or not than a predefined maximum lateral deviation value.

After the conformity determination step, the method makes it possible to configure a trajectory deviation alert (step 208) according to the result of the preceding step.

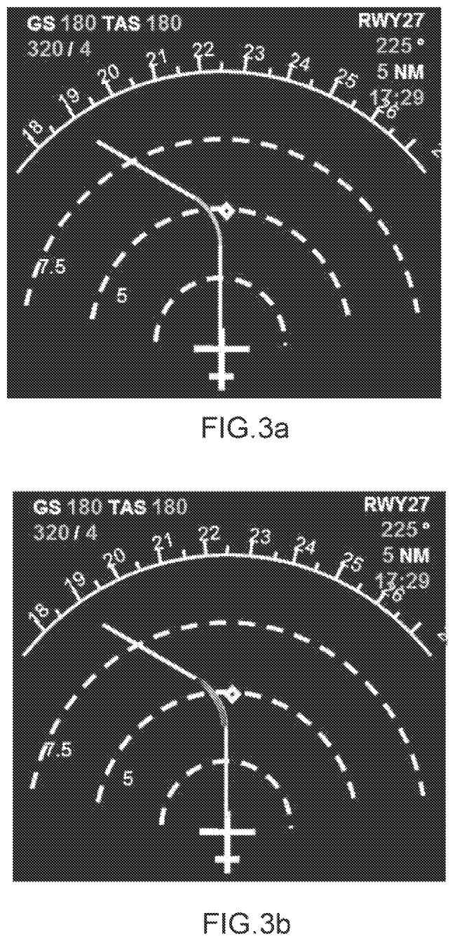

In one embodiment of prediction of the real roll of the aircraft, the method makes it possible to generate information alerting the crew and/or information communicated to an embedded system, if the predicted real roll of the aircraft exceeds the planned maximum roll (if necessary taking a margin into consideration), reflecting a trajectory nonconformity. In one embodiment, an alert can consist in a modification of the display of the trajectory on a screen of the aircraft, for example by modifying the color of the portion of the trajectory displayed in case of a prediction of exceeding the maximum roll. Thus, in an embodiment illustrated in FIG. 3a, the predicted real trajectory for the upcoming curved segment can be displayed for the crew in a specific color (for example amber) dedicated to the trajectory deviation alert, and different from the current color (for example green), if the predicted real roll exceeds a predefined threshold for the upcoming turn. In another embodiment illustrated in FIG. 3b, the predicted real trajectory for the upcoming curved segment can be displayed for the crew with a specific color dedicated to the trajectory deviation alert, and different from the current color (for example green), and the intensity of which varies along the curved segment according to the real roll value predicted with respect to the predefined maximum roll.

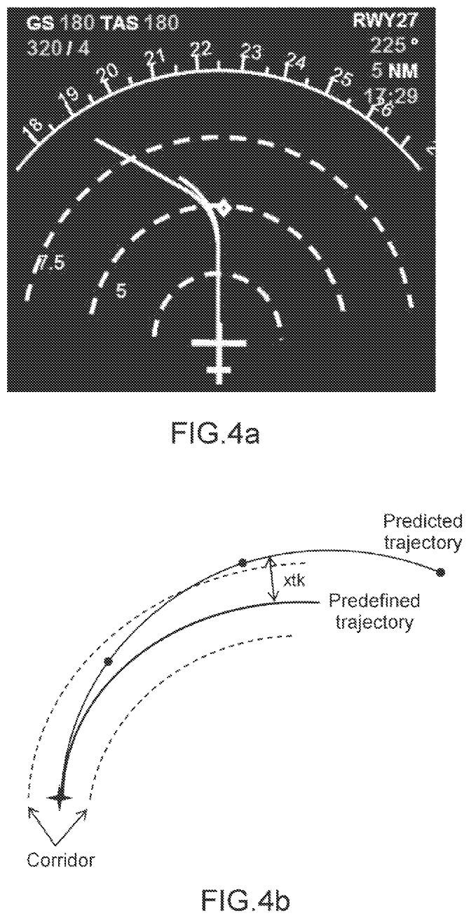

In one embodiment of prediction of the real position of the aircraft, the method makes it possible to generate information alerting the crew and/or information communicated to an embedded system, with respect to the predicted real trajectory of the aircraft, that is to say the trajectory that the aircraft will actually fly, and therefore inform the crew on the lateral deviation that the aircraft will have with respect to the predefined trajectory. In an embodiment illustrated in FIG. 4a, the predicted real trajectory for an upcoming curved segment according to the calculation of a predicted real position can be displayed in a different color (for example white) overlaid on the predefined trajectory (for example displayed in green). In another embodiment illustrated in FIG. 4b, a display of the predicted real trajectory can be done with respect to a corridor to be observed around the predefined trajectory (known in the “required navigation performance” RNP procedures), and reflect, along the curved segment, the observed maximum lateral deviation (XTKₘₐₓ) between the predicted real trajectory and the predefined trajectory.

In other embodiments, alternative to or combined with the preceding embodiments described, the configuration of an alert can consist in generating one or more alert messages (visual, audible). The person skilled in the art will be able to implement other alert forms suited to the context of application of the invention.

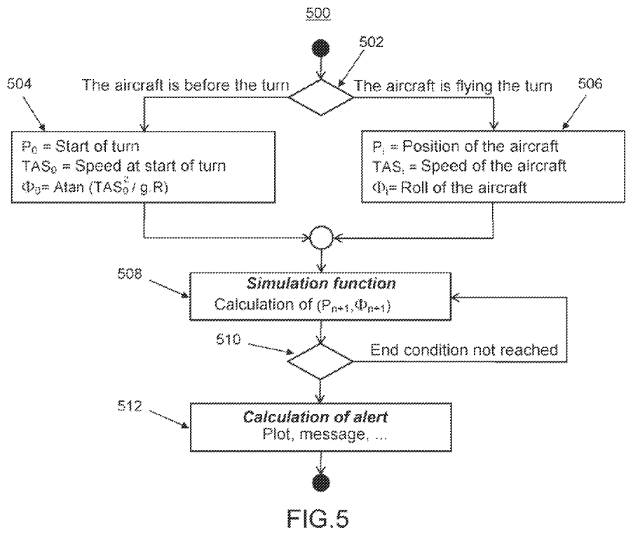

FIG. 5 illustrates steps of a variant embodiment of the method of the invention. In a first step 502, the method 500 of FIG. 5 makes it possible to determine where the aircraft is located with respect to an upcoming change of direction of the flight plan, i.e. either the aircraft is situated before the turn, or the aircraft is already engaged in the turn.

If the aircraft is situated upstream of the turn, the method, in a next step 504, makes it possible to acquire, in addition to all the general state, environment and reference trajectory variables (step 202 of FIG. 2), starting parameters defining:
a turn as a curved segment of radius R, with a starting point P₀ characterized by its latitude and its longitude, and a starting course crs₀ of this curved segment;
a starting speed TAS₀ of the aircraft at the start of the turn. In one embodiment, the starting speed is based on a predicted speed profile. In fact, the trajectory computation systems of the FMSs make it possible to know speed predictions along the trajectories. Thus, the starting speed parameter TAS₀ of the aircraft at the start of the turn can be derived from the data from the FMS such as a prediction of true speed (or TAS, for “true air speed”) of the aircraft along this curved segment. In other embodiments, the starting speed parameter is obtained by data on the prediction of calibrated speed (CAS for “calibrated air speed”) and the altitude;
a starting roll Φ₀ of the aircraft, equal to the roll of the aircraft at the position at the starting point P₀, and which can be defined by the following equation: Φ₀=Atan(TAS₀²/g·R) if an anticipation of the turn maneuver is considered. In one embodiment, another starting roll value can be taken into account according to the type of guidance used. For example, a zero starting roll value can be used if no turn maneuver anticipation is considered;
a predicted wind in the turn, characterized by two values: Windₑᵣₛ for the course from which the wind is coming, and Wind_{mag} for the magnitude or speed of the wind.

If the aircraft is already flying the turn, the method, in a next step 506, makes it possible, in addition to all the general state, environment and reference trajectory variables (step 202 of FIG. 2), and the starting parameters (step 504), to acquire current parameters of the aircraft, defining:
the current position of the aircraft Pᵢ;
the current speed of the aircraft TASᵢ; and
the current roll of the aircraft Φᵢ.

In a next step 508, the method makes it possible to implement a simulation function, to predict a real trajectory of the aircraft, either from the start of the turn for the curved segment to be flown, or from the current position of the aircraft in the turn for the curved segment remaining to be flown. The prediction calculation can, according to the embodiments, be done either by a prediction of real roll of the aircraft, or by a prediction of real position of the aircraft.

In the real roll prediction embodiment, a simulation module is configured to calculate the predicted real roll of the aircraft, based on the following equations:

$$C R {S}_{n} = C R {S}_{0} + n \times \frac{dx}{R}$$

for the curved segments to the right, or

$$C R {S}_{n} = C R {S}_{0} - n \times \frac{dx}{R}$$

for the curved segments to the left, with dx a parameter which defines the value of the pitch allowing the calculation to be discretized; and

Vₙ=TASₙ+Wind_{mag}×cos(Wind_{crs}+180°−Crsₙ).

The predicted real roll is then obtained by the following equation:

$${Φ}_{n} = {tan}^{- 1} ( \frac{{V}_{n}^{2}}{g \cdot R} )$$

in which ‘g’ is the gravitational constant.

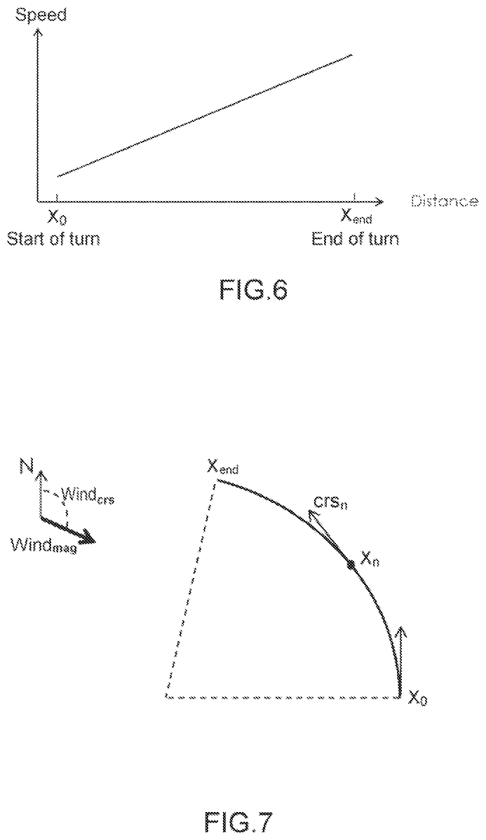

FIG. 6 and FIG. 7 are representations of the parameters used for the real roll prediction calculation. The simulation module makes it possible to calculate the predicted real roll for ‘n’ positions Xₙ of the aircraft along the curved segment, between a start position (X₀ or Xᵢ) and an end position X_{end} (iteration of step 510).

The simulation module is also configured to verify the prediction value obtained at each position (step 206 of FIG. 2), and to generate, if appropriate, a trajectory deviation alert (step 512) according to a predefined alert configuration.

Thus, in the embodiment applied to the prediction of real roll of the aircraft, if, for at least one of the ‘n’ positions, the predicted real roll is greater in absolute value than the predefined maximum roll, which can be set in advance or else defined as the trajectory roll with a predefined margin added, then the curved segment is considered as not flyable and an alert can be raised (FIG. 3a; FIG. 3b; message).

In the real position prediction embodiment, a simulation module is configured to calculate, with a predefined time step dₜ, a theoretical position of the aircraft associated with a roll (Pₙ₊₁, Φₙ₊₁) which is a function of its preceding position (Pₙ, Φₙ). The person skilled in the art can adapt the simulation function in a more or less complex manner according to the expected accuracy of the calculation, or even according to technical implementation constraints, such as, for example, the time of execution of the required calculation.

Thus, in a particular implementation, the simulation function can be based on the usual equations of flight mechanics:

$${V}_{n} = {TAS}_{n} + {Wind}_{mag} \cdot cos ( {Wind}_{crs} + 180 ° - {crs}_{n} ) ; and \\ {crs}_{n + 1} = c r {s}_{n} + \frac{g \cdot tan ( {Φ}_{n} )}{{V}_{n}} \cdot dt$$

The predicted real position of the aircraft is then obtained by the following equation:

$${P}_{n + 1} = P B D ( {P}_{n} , \frac{{crs}_{n} + {crs}_{n + 1}}{2} , {V}_{n} \cdot dt ) ,$$

in which ‘PBD’ is a standard known function for calculating a geographic position from a starting position, from a direction and from a distance.

If Pₙ₊₁ corresponds to a position where the aircraft is located within a turn to the right or outside of a turn to the left, the roll is calculated according to the following equation:

Φₙ₊₁=Max(−Φₘₐₓ,Min(Φₘₐₓ,Φₙ−RollRate·dt).

If Pₙ₊₁ corresponds to a position where the aircraft will not be located either within a turn to the right, or outside of a turn to the left, the roll is calculated according to the following equation:

Φₙ₊₁=Max(−Φₘₐₓ,Min(Φₘₐₓ,Φₙ+RollRate·dt)

The simulation function operates as long as an end condition is not reached (step 510). According to different options, a simulation end condition can be defined by:
a certain change of course being reached, by the verification of the condition: |crs_{end}−crs₀|>Threshold;
a certain flight distance being travelled;
a certain flight time being travelled; or even
a predefined trajectory being rejoined.

Based on the results of the simulation, the method makes it possible to calculate a series of segments making it possible to plot a predicted real trajectory of the aircraft. This series of segments can, by choice, be a series of straight segments defined by positions [Pₙ, Pₙ₊₁], or a series of circular arcs defined by a starting position Pₙ, a starting roll Φₙ, a radius

$$R = \frac{{V}_{n}^{2}}{g \cdot tan ( {Φ}_{n} )}$$

and an end position Pₙ₊₁.

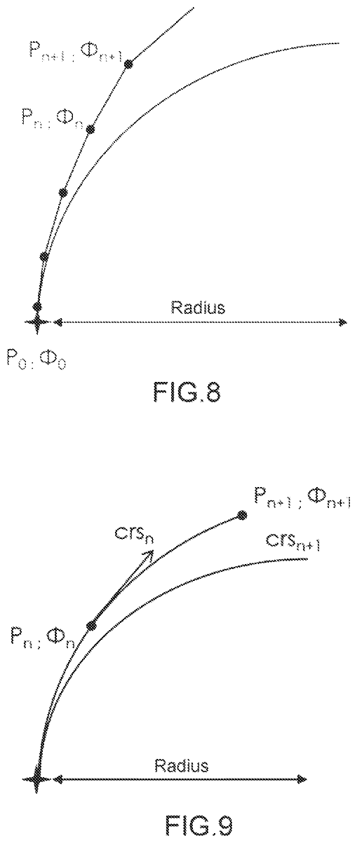

FIGS. 8 and 9 are representations of the parameters used for the real position prediction calculation, over a series of straight segments (FIG. 8) and over a series of circular arcs (FIG. 9).

The simulation module is also configured to verify the conformity of the predicted real trajectory to a predefined trajectory, and to generate, if necessary, a trajectory deviation alert (step 512) according to a predefined alert configuration.

Thus, in the embodiment applied to the prediction of real position of the aircraft, an alert can be generated (FIG. 4a; FIG. 4b; message), if the value of the observed maximum lateral deviation (XTKₘₐₓ) between the predicted real trajectory and the predefined trajectory does not conform to a maximum value defined with respect to a corridor (RNP) to be observed around the predefined trajectory.

Thus, the solution described makes it possible to be able to inform the crew of an aircraft or another system (an embedded system or an air traffic control system) in advance a problem in following a trajectory. Advantageously, the a priori announcement and alert make it possible to anticipate a resolution of a problem in following a trajectory, and thus equally reduce the load of the pilot and enhance the safety of the flight.

In fact, at certain airports, the procedure must be followed precisely in order to guarantee the separation of the aircraft with the relief (known RNP-AR procedure). Now, to date, safety is ensured only by a prior training of the pilots in order to guarantee that the trajectory will be correctly followed. The addition of the method of the invention makes it possible to implement monitoring, by the pilot or else by a system, in order to alert to the non-observance of this procedure.

Furthermore, in some FMS configurations, there is a desire to calculate the trajectory with the planned speed instead of the predicted speed, and do so in order to have a trajectory that is as close as possible to the official procedure. With this invention, it is possible to inform the crew on the observance or non-observance of this trajectory by the guidance system and to take the measures necessary to ensure that the flight proceeds correctly.

To sum up, the invention provides particular advantages on:
the work load, by allowing anticipation of the resolution of a problem in following a trajectory; and
safety, by offering an early alert of non-observance of a turn.

The present description illustrates a preferential implementation of the invention, but is not limiting. Examples have been chosen to allow a good understanding of the principles of the invention, and a solid application, but they are not exhaustive and should allow the person skilled in the art to add modifications and implementation variants while keeping to the same principles.

1. A method for assisting aircraft guidance, the method being operated by a computation platform for aircraft and comprising at least:
a step of acquisition of state variables characterizing an aircraft in flight, of environment variables characterizing the environment of the aircraft and of trajectory variables characterizing a reference trajectory of the aircraft,
a step of calculation of a predicted real trajectory consisting in calculating prediction variables based on said state variables, environment variables and reference trajectory variables, the prediction variables characterizing the prediction of a real roll and/or of a real position of the aircraft for an upcoming change of direction of the aircraft;
a step of determination of conformity to determine if the predicted real trajectory which is calculated conforms or does not conform to the reference trajectory; and
if the predicted real trajectory does not conform to the reference trajectory, a step of configuration of a trajectory deviation alert informing of the roll and/or of the lateral deviation of the aircraft with respect to the reference trajectory on the upcoming change of direction.

2. The method as claimed as claim 1, wherein the conformity determination step consists in comparing the values of said prediction variables to predefined threshold values for the reference trajectory of the aircraft.

3. The method as claimed in claim 2, wherein the conformity determination step consists in verifying if the predicted real roll value is greater than a predefined maximum roll value and/or in verifying if the predicted real position of the aircraft corresponds to a lateral deviation value greater than a predefined maximum lateral deviation value.

4. The method as claimed in claim 1, wherein the step of calculation of a predicted real trajectory comprises an initial step of determination of the position of the aircraft with respect to an upcoming change of direction, making it possible to determine if the aircraft is situated before the upcoming change of direction or if the aircraft has already engaged in the turn corresponding to the change of direction.

5. The method as claimed in claim 4, wherein the step of calculation of a predicted real trajectory consists in implementing a simulation function to predict a real trajectory of the aircraft, either from the start of the turn for the turn to be flown, or from the current position of the aircraft in the turn for the turn segment remaining to be flown.

6. A device for assisting aircraft guidance comprising means for:
acquiring state variables characterizing an aircraft in flight, environment variables characterizing the environment of the aircraft and trajectory variables characterizing a reference trajectory of the aircraft;
calculating a predicted real trajectory of the aircraft from said state variables, environment variables and reference trajectory variables, by calculating prediction variables characterizing the prediction of a real roll and/or of a real position of the aircraft for an upcoming change of direction of the aircraft;
determining if the calculated predicted real trajectory conforms or does not conform to the reference trajectory; and
configuring a trajectory deviation alert if the predicted real trajectory does not conform to the reference trajectory, the alert being configured to inform of the roll and/or of the lateral deviation of the aircraft with respect to the reference trajectory, on the upcoming change of direction.

7. A device for assisting aircraft guidance comprising means for:
acquiring state variables characterizing an aircraft in flight, environment variables characterizing the environment of the aircraft and trajectory variables characterizing a reference trajectory of the aircraft;
calculating a predicted real trajectory of the aircraft from said state variables, environment variables and reference trajectory variables, by calculating prediction variables characterizing the prediction of a real roll and/or of a real position of the aircraft for an upcoming change of direction of the aircraft;
determining if the calculated predicted real trajectory conforms or does not conform to the reference trajectory; and
configuring a trajectory deviation alert if the predicted real trajectory does not conform to the reference trajectory, the alert being configured to inform of the roll and/or of the lateral deviation of the aircraft with respect to the reference trajectory, on the upcoming change of direction,
further comprising means configured to operate the steps of the method as claimed in claim 2.

8. A flight management system (FMS) comprising a device for assisting aircraft guidance as claimed in claim 6.

9. A computer program product, said computer program comprising code instructions making it possible to perform the steps of the method for assisting aircraft guidance as claimed in claim 1, when said program is run on a computer.
